(19) United States
(12) Patent Application Publication
(10) Pub. No.: US 2007/0248018 A1
(43) Pub. Date: Oct. 25, 2007

(54) BUS ANALYZER SYSTEM FOR IEEE 1394 LINK/PHY INTERFACE

(75) Inventors: Michael J. Ranallo, St. Petersburg, FL (US); Paul M. Self, Oldsmar, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/379,650

(22) Filed: Apr. 21, 2006

(51) Int. Cl. H04L 12/26

(52) U.S. Cl. 370/241

(57) ABSTRACT

A bus analyzer system comprises an input buffers module, a data memory module, a control detection module, a link request registers module, and a computer interface. The input buffers module is configured to receive data signals from a plurality of serial data, control, and clock lines at an interface between a physical layer and a link layer of an IEEE-1394 bus device. The computer interface is configured for operative communication with a computer that stores application software having algorithms for carrying out instructions for data interleaving, data formatting, error detection, time tracking, and display. The bus analyzer system allows a user to view all activity at the interface between the link layer and the physical layer within any IEEE-1394 bus device. The bus analyzer system automates the process of capturing each of the high speed serial data or control streams, and reconstructs, displays, and time-stamps the properly formatted 1394 transaction, data, or command signals.

### GOVERNMENT LICENSE RIGHTS

The U.S. Government may have certain rights in the present invention as provided for by the terms of Contract No. F04701-02-C-0502 awarded by Raytheon Infrared Opns SG-6AT728-G.

### BACKGROUND TECHNOLOGY

The Institute of Electrical and Electronics Engineers (IEEE) 1394 multimedia digital interface (also known as “FireWire”) is a hardware and software bus standard for high speed data communication. The IEEE-1394 digital interface provides high-bandwidth real-time data interfacing between computers, peripherals, and consumer electronics products such as camcorders, video recorders, printers, televisions, digital cameras, and the like. The IEEE-1394 interface is also used in high-end applications like medical imaging, digital cinema, and professional video broadcast, as well as air and space flights.

The components that form an IEEE 1394 based network include the 1394 bus protocol, the cabling system, and the architectural design of the network. The bus protocol uses a layered approach to transmit data across a physical medium, with each layer including a logical grouping of functions. A physical (PHY) layer provides the electrical and mechanical connection between the 1394 bus and cable system for data transmission and reception tasks. The physical layer also provides arbitration to ensure that all connected devices have fair access to the 1394 bus. A link (LINK) layer takes the raw data from the physical layer and formats it into two types of recognizable 1394 packets—isochronous (real-time) and asynchronous. The packets are transmitted to a transaction layer that is responsible for managing the commands that are executed across the network.

Currently, there is no bus analyzer or other instrumentation dedicated to analyzing, troubleshooting, verifying, or validating communication across a standard 1394 LINK/PHY interface. Initial development and troubleshooting of 1394-based board designs for new applications have been detrimentally impacted due to the unavailability of any type of LINK/PHY interface bus analyzer. All troubleshooting, verification, and validation of this interface can be performed only with an oscilloscope. The current approach to analyzing bus activity involves manually capturing and interleaving or “building” the actual data stream using up to 7 serial bit patterns, a process that is both tedious and prone to error. Thus, test engineers are forced to expend excessive hours to collect data that is often less than ideal.

### BRIEF DESCRIPTION OF THE DRAWINGS

Features of the present invention will become apparent to those skilled in the art from the following description with reference to the drawings. Understanding that the drawings depict only typical embodiments of the invention and are not therefore to be considered limiting in scope, the invention will be described with additional specificity and detail through the use of the accompanying drawings, in which:

FIG. 1 is a schematic circuit diagram depicting a conventional 1394 LINK/PHY interface;

FIG. 2 is a schematic block diagram showing a bus analyzer system for a 1394 LINK/PHY interface according to an embodiment of the present invention; and

FIG. 3 depicts the bus analyzer system of FIG. 2 electrically connected to the 1394 LINK/PHY interface of FIG. 1.

### DETAILED DESCRIPTION

In the following detailed description, embodiments are described in sufficient detail to enable those skilled in the art to practice the invention. It is to be understood that other embodiments may be utilized without departing from the scope of the present invention. The following detailed description is, therefore, not to be taken in a limiting sense.

The present invention is directed to a bus analyzer system for a 1394 LINK/PHY interface. In general, the present bus analyzer system will aid a user such as design, systems, software, and test engineers, in viewing all activity between the 1394 LINK and PHY layers within any 1394 LINK/PHY bus device interface. Such an interface typically requires from 2 to 8 interleaved 50 MHz serial data lines, depending on the required 1394 bit rates.

The present invention also provides a method of analyzing one or more serial data streams at the interface between 1394 LINK and PHY layers of an IEEE-1394 bus device. The method generally comprises capturing the one or more serial data streams from the interface, decoding the one or more serial data streams, and displaying information from the decoded serial data streams.

The present system automates the process of capturing each of the high speed serial data streams, and builds (reconstructs), displays, and time-stamps the properly formatted 1394 transaction, data, or command signals using on-board software decoding and display algorithms. Additionally, the system of the invention decodes the LINK/PHY interface control, as well as the link request (LReq) and link on signals, in order to capture and display data source, data speed, interface state, and LReq commands information to the user. Further details of the present bus analyzer system are described hereafter.

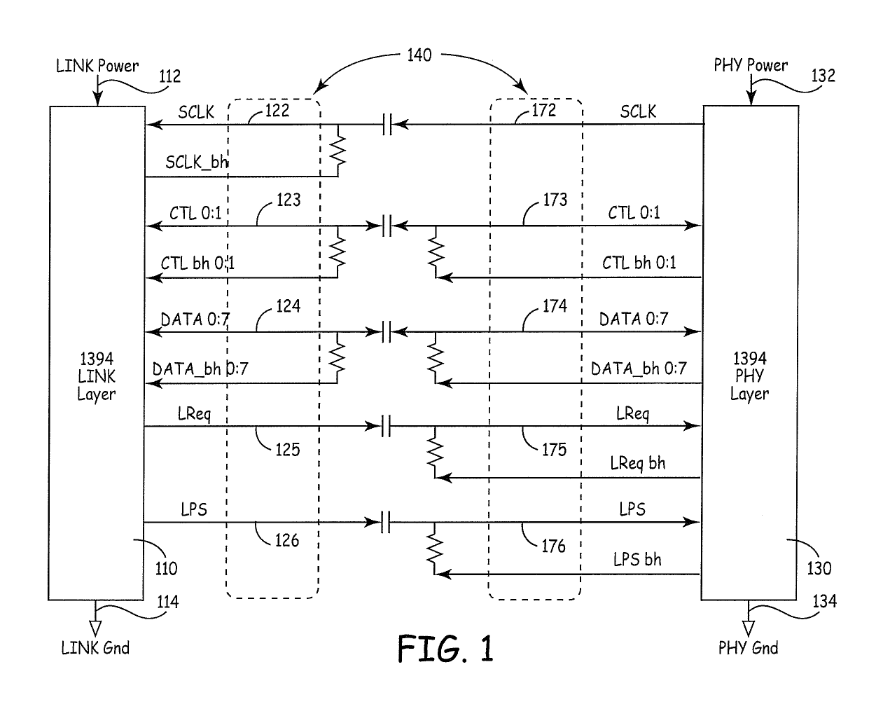

FIG. 1 is a schematic circuit diagram depicting a conventional 1394 LINK/PHY interface. A 1394 LINK layer 110 is electrically interconnected with a 1394 PHY layer 130 to form a LINK/PHY interface 140. The LINK layer 110 has a LINK power line 112 at one end thereof and a LINK ground line 114 at an opposite end. The PHY layer 130 has a PHY power line 132 at one end thereof and a PHY ground line 134 at an opposite end. A plurality of clock and control lines 122, 172, 123, 173, 125, 175, 126, 176, and serial data lines 124, 174 provide electrical communication between LINK layer 110 and PHY layer 130.

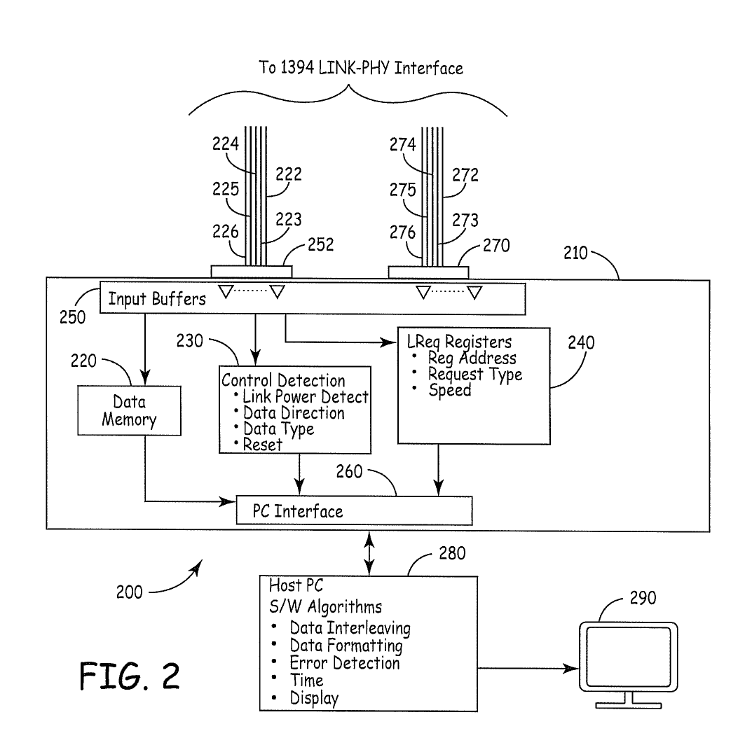

FIG. 2 is a schematic block diagram showing a bus analyzer system 200 for a 1394 LINK/PHY interface, according to one embodiment of the present invention. Various hardware and software components are used in bus analyzer system 200. The hardware components can be implemented on a printed wiring board (PWB) 210 or other conventional printed circuit cards. As shown in FIG. 2, the bus analyzer system 200 generally includes a data memory module 220, a control detection module 230, and a link request (LReq) registers module 240, all of which are in operative communication with an input buffers module 250 and a computer (PC) interface 260.

The input buffers module 250 is in operative communication with a LINK interface channel 252 that receives data signals from a series of input lines 222-226. The input buffers module 250 is also in operative communication with a PHY interface channel 270 that receives data signals from input lines 272-276.

The data memory module 220 includes one or more devices such as RAM, EEPROM, or flash memory. The data memory module 220 is configured to save each of the high speed serial data or control streams from input buffers module 250 for retrieval by the application software discussed hereafter.

The control detection module 230 includes logic that detects and captures the LINK/PHY interface control data, and makes this data available to the application software for decoding. In particular, the control detection module 230 provides for detecting Link power, data direction, data type, and reset.

The LReq registers module 240 includes logic that detects and captures LINK generated commands to the PHY layer, including register address, request type, and data speed.

The computer interface 260 is in operative communication with a host computer 280 such as a personal computer (PC). The host computer 280 stores the application software that has algorithms for data interleaving, data formatting, error detection, time stamping, and display. The host computer 280 is configured to display the results from bus analyzer 200 on a monitor 290.

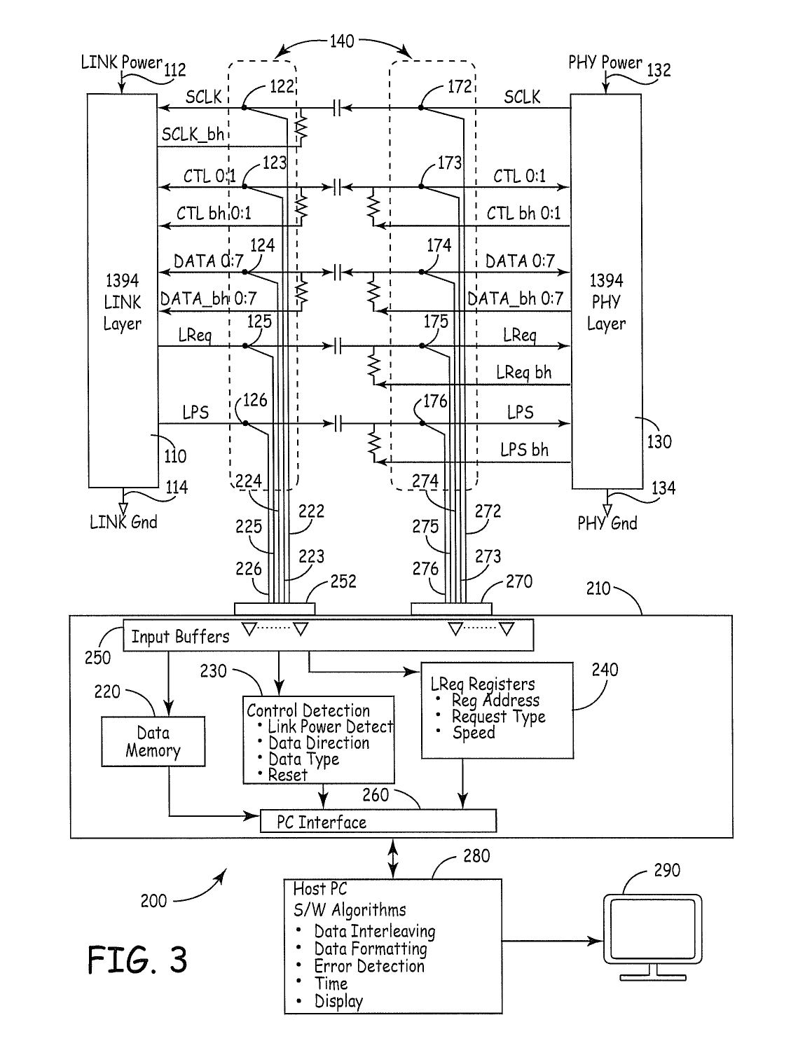

FIG. 3 depicts bus analyzer system 200 electrically connected to a 1394 LINK/PHY interface such as interface 140 in FIG. 1. As shown, input lines 222-226 are electrically connected to serial data, clock, and control lines 122-126, respectively, of interface 140. Input lines 272-276 are electrically connected to serial data, clock, and control lines 172-176, respectively, of interface 140.

During operation of bus analyzer system 200, a LINK-PHY data analysis is conducted by capturing each of the high speed serial data streams and saving them to the on-board data memory module 220 for retrieval by the application software for decoding. A software algorithm is used to build (reconstruct), display, and time-stamp the properly formatted 1394 transaction, data, or command signals, and detects bit pattern errors. The results are displayed to a user on monitor 290.

In an interface control analysis, control detection module 230 of bus analyzer system 200 detects and captures the LINK/PHY interface control bits, and makes them available to the software algorithms for decoding. The decoded data including data direction, time tracking, or status is displayed to a user on monitor 290.

During a link request (LReq) analysis, the LReq registers module 240 is used to capture LINK generated command signals to the PHY layer. Additionally the status of the LPS and Link On discretes are monitored and captured. The algorithms are used to monitor, decode and validate the captured LReq bit stream and generate a display of command, data source, data speed, interface state, time, or read/write data information on monitor 290.

Instructions for carrying out the various methods, process tasks, calculations, control functions, and the generation of signals and other data used in the operation of the system of the invention are implemented, in some embodiments, in software programs, firmware, or computer readable instructions. These instructions are typically stored on any appropriate computer readable medium used for storage of computer readable instructions or data structures. Such computer readable media can be any available media that can be accessed by a general purpose or special purpose computer or processor.

By way of example, and not limitation, such computer readable media can include floppy disks, hard disks, ROM, flash memory ROM, nonvolatile ROM, EEPROM, RAM, CD-ROM, DVD-ROM, or other optical disk storage, magnetic disk storage, or other magnetic storage devices, or any other medium that can be used to carry or store desired program code means in the form of computer executable instructions or data structures. When information is transferred or provided over a network or another communications connection (either hardwired, wireless, or a combination of hardwired or wireless) to a computer, the computer properly views the connection as a computer readable medium. Thus, any such connection is properly termed a computer readable medium. Combinations of the above are also included within the scope of computer readable media. Computer executable instructions comprise, for example, algorithms or other data which cause a general purpose computer, special purpose computer, or special purpose processing device to perform a certain function or group of functions.

The present invention may be embodied in other specific forms without departing from its essential characteristics. The described embodiments are to be considered in all respects only as illustrative and not restrictive. The scope of the invention is therefore indicated by the appended claims rather than by the foregoing description. All changes that come within the meaning and range of equivalency of the claims are to be embraced within their scope.

What is claimed is:

1. A bus analyzer system, comprising:
an input buffers module;
a data memory module in operative communication with the input buffers module;
a control detection module in operative communication with the input buffers module;
a link request registers module in operative communication with the input buffers module; and
a computer interface in operative communication with the data memory module, the control detection module, and the link request registers module.

2. The system of claim 1, further comprising a LINK interface channel in operative communication with the input buffers module, the LINK interface channel configured to receive data signals from a set of input lines that are electrically connected to a plurality of serial data, clock, and control lines of a LINK/PHY interface of an IEEE-1394 bus device.

3. The system of claim 1, further comprising a PHY interface channel in operative communication with the input buffers module, the PHY interface channel configured to receive data signals from a set of input lines that are electrically connected to a plurality of serial data, clock, and control lines of a LINK/PHY interface of an IEEE-1394 bus device.

4. The system of claim 1, wherein the input buffers module, the computer interface, the data memory module, the control detection module, and the link request registers module are attached to a printed wiring board.

5. The system of claim 1, wherein the computer interface is in operative communication with a computer that stores application software having algorithms for carrying out instructions for data interleaving, data formatting, error detection, time tracking, and display.

6. The system of claim 1, wherein the data memory module includes one or more devices comprising RAM, EEPROM, or flash memory.

7. The system of claim 1, wherein the data memory module is configured to save serial data or control streams from the input buffers module.

8. The system of claim 1, wherein the control detection module is configured to detect and capture control signals from an interface between a physical layer and a link layer of an IEEE-1394 bus device.

9. The system of claim 8, wherein the control signals comprise link power, data direction, data type, and reset.

10. The system of claim 1, wherein the link request registers module is configured to capture link layer generated command signals to the physical layer.

11. The system of claim 10, wherein the command signals comprise register address, request type, or data speed.

12. A method of analyzing one or more serial data or control streams at an interface between a physical layer and a link layer of an IEEE-1394 bus device, the method comprising:
capturing the one or more serial data or control streams from the interface;
decoding the one or more serial data or control streams; and
displaying information from the decoded serial data or control streams.

13. The method of claim 12, further comprising saving the one or more serial data or control streams, and retrieving the saved serial data or control streams for decoding.

14. The method of claim 13, wherein the decoded serial data or control streams comprise reconstructed transaction signals, data signals, command signals, or bit pattern errors.

15. The method of claim 12, wherein the displayed information is time-stamped.

16. The method of claim 12, wherein the captured serial data or control streams comprise control bits from the interface between the physical layer and the link layer of the IEEE-1394 bus device.

17. The method of claim 16, wherein the control bits are decoded to display information comprising data direction, time, or status.

18. The method of claim 12, wherein the captured serial data or control streams comprise link layer generated command signals to the physical layer.

19. The method of claim 18, wherein the command signals are decoded to display information comprising command data, data source, data speed, interface state, time tracking, or read/write data.

20. A computer readable medium having instructions stored thereon for a method of analyzing one or more serial data or control streams at an interface between a physical layer and a link layer of an IEEE-1394 bus device, the method comprising:
capturing one or more serial data or control streams from the interface;
decoding the serial data or control streams comprising transaction signals, data signals, command signals, interface control signals, link request signals, or link on signals; and
displaying information from the decoded serial data or control streams comprising time-stamp, command data, data source, data speed, interface state, time tracking, read/write data, data direction, status, or bit pattern errors.
